(19) United States
(12) Patent Application Publication
(10) Pub. No.: US 2020/0180985 A1
(43) Pub. Date: Jun. 11, 2020

(54) Heavy Metal Treatment Composite Microbial Agent in Water and Preparation Method Thereof

(71) Applicant: Jiangnan University, Wuxi (CN)

(72) Inventors: Xu Zhan, Wuxi (CN); Zhuo Chen, Wuxi (CN); Jingxi Wang, Wuxi (CN)

(21) Appl. No.: 16/404,985

(22) Filed: May 7, 2019

(30) Foreign Application Priority Data
Dec. 10, 2018 (CN) 201811503723.8

(51) Int. Cl. C02F 3/34

(52) U.S. Cl. CPC C02F 3/347; C02F 2101/22; C02F 3/341

(57) ABSTRACT

The present invention discloses a heavy metal treatment composite microbial agent in water and a preparation method thereof, belonging to the field of heavy metal treatment. The microbial agent of the present invention is prepared from the following components in parts by weight: 20-30 parts of Pseudomonas, 15-30 parts of Bacillus, 5-15 parts of Staphylococcus, and 5-15 parts of Pichia pastoris. The microbial agent of the present invention can quickly and efficiently adsorb and remove heavy metal ions, and the removal efficiencies of the microbial agent of the present invention on the cadmium, copper, lead and chromium after 2 d reach 81.0%, 56.5%, 52.0% and 74.0% respectively, wherein the adsorption and removal effects on the cadmium and chromium are most obvious. In addition, the microbial agent of the present invention can effectively improve the removal efficiency of the pollutants in the sewage to be treated, can achieve 80% CODMn removal rate or more, 85% TN removal rate or more, 80% TP removal rate or more, and 80% NH₄⁺-N removal rate or more with a small amount, meets the pollutant discharge standards of the sewage treatment plant, and has a good application prospect.

### TECHNICAL FIELD

The disclosure herein relates to a heavy metal treatment composite microbial agent in water and a preparation method thereof, belonging to the field of heavy metal treatment

### BACKGROUND

With the development of economy and society, the types of heavy metal wastewater are increasing. Industrial wastewater such as electroplating, mining and metal manufacturing, industrial machine production, photography and painting, pesticides, textiles, paints and dyes often contains cadmium, copper, nickel, tin, calcium and other heavy metals. The heavy discharge of heavy metal wastewater makes heavy metal one of the important pollutants of environmental water pollution. Unlike organic pollutants, heavy metals do not decay, so once water is contaminated with heavy metals, it is difficult to repair. In addition, the biological effects of heavy metals are long-lived. Most metal ions and their compounds are easily adsorbed by suspended particles in water and precipitated in the sedimentary layer of the bottom of the water, which pollutes the water body for a long time. Certain heavy metals and their compounds can be enriched, accumulated, and involved in the biosphere cycle in fish and other aquatic organisms as well as in crop tissues. Through the actions of drinking water and the food chain, people make heavy metals be enriched in the body and thus are poisoned, and even dead. The “itai-itai disease” that shocked the world is caused by chronic poisoning of cadmium, which causes cadmium to replace calcium in bones and soften the bones. People eventually die of comorbidities such as disuse atrophy, complicated renal failure and infection. Heavy metal pollution is also often accompanied by pollution of harmful substances such as cyanogen, arsenic and fluorine, which cause great harm to the human body. For example, fluoride can cause osteoporosis, bone proliferation or deformation, and can also cause eczema and various dermatitis; and arsenic and all arsenic-containing compounds accumulated in the human body are carcinogenic and teratogenic substances.

At present, heavy metal treatment technologies mainly comprise chemical treatment, physicochemical treatment and biological treatment. Common methods that have been reported so far, comprising chemical precipitation, coagulation-flocculation, electrochemical processes, membrane separation, ion exchange and adsorption, have corresponding limitations. For example, chemical precipitation has poor treatment effect on low-concentration heavy metal wastewater. Because of the precipitation of hydroxide, a large amount of low-density precipitates are produced. Thus, the workload of dehydration and disposal of precipitates is increased, and under acidic conditions, sulfide precipitants produce secondary pollutants such as H2S. The operation cost of the coagulation-flocculation process is high, and the sludge volume generated in the process is continuously increased, which hinders the adsorption of heavy metals by the sludge in the wastewater treatment. Electrochemical treatment technology requires high investment cost and high electric expenses. Membrane separation (microfiltration, ultrafiltration, nanofiltration, reverse osmosis) can cause problems such as membrane fouling, clogging and low transmission rate. Ion exchange resins are not suitable for removing all heavy metals and have poor universality. In order to remove different types of heavy metals in wastewater, different ion exchange resins are needed.

Due to its wide range of raw materials, low price and fast adsorption, biosorbents have attracted the attention of many researchers in the field of heavy metal wastewater treatment. A microbial agent is a preparation prepared by combined or mixed culture of a plurality of microorganisms having different degradation functions, mutual or symbiotic relationships in an appropriate ratio. It is a commonly used bio-enhancement technology by adding a functional microbial agent to a wastewater treatment system to improve the treatment efficiency on refractory organic pollutants. However, this technology has not yet matured research on heavy metal treatment. Therefore, there is an urgent market demand for inventing a rapid and inexpensive method for treating heavy metal ions by microbial agents.

### SUMMARY

In order to solve the above problems, the present invention provides a microbial agent which has a good removal effect on heavy metal ions and also has good decontamination performance. The microbial agent has the characteristics comprising strong pertinence, quick effect and easy operation, and has a good application prospect in environmental organic pollution control.

A first object of the present invention is to provide a microbial agent, wherein the microbial agent is prepared from the following components in parts by weight: 20-30 parts of Pseudomonas, 15-30 parts of Bacillus, 5-15 parts of Staphylococcus, and 5-15 parts of Pichia pastoris.

In one example of the present invention, the microbial agent is prepared from the following components in parts by weight: 25 parts of Pseudomonas, 20 parts of Bacillus, 15 parts of Staphylococcus and 10 parts of P. pastoris.

In one example of the present invention, the Pseudomonas comprises one or more of Pseudomonas aeruginosa, Pseudomonas brenneri, Pseudomonas putida, and Pseudomonas stutzeri.

In one example of the present invention, the Bacillus comprises Bacillus cereus.

In one example of the present invention, the P. pastoris comprises Pichia membranifaciens.

In one example of the present invention, the preparation method of the microbial agent comprises:

mixing Pseudomonas, Bacillus, Staphylococcus, and P. pastoris according to parts by weight to obtain the microbial agent.

In one example of the present invention, the microbial agent may further be prepared from the following component in parts by weight: 5-20 parts of Fusarium.

A second object of the present invention is to provide a heavy metal ion treatment method, wherein the method uses the above microbial agent.

In one example of the present invention, the added amount of the microbial agent in the method is not less than 0.2%.

In one example of the present invention, the method further comprises enriching the microbial agent onto a carrier, the carrier being a spongy cube carrier ACP or PM.

In one example of the present invention, the content of the strain relative to the carrier is not less than 10 μg/g.

In one example of the present invention, the content of the strain relative to the carrier is preferably 50-150 μg/g.

In one example of the present invention, the interior of the carrier is a staggered network structure, and the individual volume is 1 dm³.

A third object of the present invention is to provide a sewage treatment method, wherein the method performs sewage treatment by using the above-mentioned microbial agent or using the above-mentioned heavy metal ion treatment method.

In one example of the present invention, the added amount of the microbial agent in the method is not less than 0.2%.

In one example of the present invention, the method further comprises enriching the microbial agent onto a carrier, the carrier being a spongy cube carrier ACP or PM.

In one example of the present invention, the content of the strain relative to the carrier is not less than 10 μg/g.

In one example of the present invention, the content of the strain relative to the carrier is preferably 50-150 μg/g.

In one example of the present invention, the interior of the carrier is a staggered network structure, and the individual volume is 1 dm³.

The present invention has the following beneficial effects:

1. The microbial agent of the present invention can effectively improve the removal efficiency of pollutants in the sewage to be treated, can achieve 80% CODMn removal rate or more, 85% TN removal rate or more, 80% TP removal rate or more, and 80% NH4+-N removal rate or more with a small amount, and meets the pollutant discharge standards of the sewage treatment plant;

2. The microbial agent of the present invention can quickly and efficiently adsorb and remove heavy metal ions. The microbial agent of the present invention has good adsorption and removal effects on heavy metal ions such as cadmium, copper, lead and chromium. The removal efficiencies on cadmium, copper, lead and chromium after 2 d respectively reach 81.0%, 56.5%, 52.0% and 74.0%, wherein the adsorption and removal effects on cadmium and chromium are the most significant. Thus, the microbial agent has a good application prospect.

### DETAILED DESCRIPTION

The sewage of the present invention is taken from the river ecological sewage of a community in Wuxi City, Jiangsu Province, China: pH is 6.53, COD_{Mn} is 54.61 mg/L, TN mass concentration is 35.15 mg/L, TP mass concentration is 3.14 mg/L, and NH₄⁺-N mass concentration is 31.58 mg/L.

### Example 1

Preparation of microbial agent: Pseudomonas aeruginosa CICC 10351 and Bacillus cereus CICC 21155 were respectively cultured in a nutrient broth agar medium to obtain P. aeruginosa CICC 10351 fermentation broth and B. cereus CICC 21155 fermentation broth; Staphylococcus CICC 10311 was cultured in a wort agar medium to obtain Staphylococcus CICC 10311 fermentation broth; Pichia membranifaciens CICC 33242 was cultured in a wort agar medium to obtain P. membranifaciens CICC 33242 fermentation broth;

According to parts by weight, 25 parts of the P. aeruginosa CICC 10351 fermentation broth, 20 parts of the B. cereus CICC 21155 fermentation broth, 15 parts of the Staphylococcus CICC 10311 fermentation broth, and 10 parts of the P. membranifaciens CICC 33242 fermentation broth were mixed to obtain a composite microbial agent.

1000 mL of sewage water sample was taken, and 0.2%, 0.25%, 0.3%, 0.5% and 1% by mass of microbial agents were respectively added for water degradation experiments. The culture was performed at a temperature of 30° C. for 72 h respectively. The removal effects on COD_{Mn}, TN, TP and NH₄⁺-N were determined. The specific removal rate results are shown in Table 1.

TABLE 1
Removal effects of different added amounts of microbial
agent on COD_{Mn}, TN, TP and NH₄⁺—N

| Added Amount | | | | |
|---|---|---|---|---|
| of Microbial | COD_{Mn} | TN | TP | NH₄⁺—N |
| Agent | (mg/L) | (mg/L) | (mg/L) | (mg/L) |
| 0 (not added) | 54.61 | 35.15 | 3.14 | 31.58 |
| 0.2% | 9.88 | 6.93 | 0.62 | 6.22 |
| 0.25% | 7.35 | 5.75 | 0.49 | 4.96 |
| 0.3% | 6.02 | 4.96 | 0.35 | 3.45 |
| 0.5% | 5.64 | 4.20 | 0.22 | 2.89 |
| 1% | 4.89 | 3.86 | 0.19 | 2.05 |

Detection methods: COD_{Mn} was determined by an acidic permanganate oxidation method (GB 11892-1989); TN was determined by an alkaline potassium persulfate ultraviolet spectrophotometry (GB 11894-89); NH₄⁺-N was determined by Nessler reagent colorimetry (GB 7479-87); and TP was determined by potassium persulfate oxidation-molybdenum antimony anti-spectrophotometry (GB11893-89).

It can be seen from Table 1 that the microbial agent can achieve 80% COD_{Mn} removal rate or more, 85% TN removal rate or more, 80% TP removal rate or more, and 80% NH₄⁺-N removal rate or more with a small amount, and meets the pollutant discharge standards of the sewage treatment plant.

### Example 2

The microbial agent was prepared according to the formula shown in Example 1. 0.2% microbial agent was enriched in 20 mg spongy cube carrier ACP membrane at room temperature for 24 h; and 1000 mL of sewage water sample was taken, and the enriched carrier ACP membrane was added to the sewage for water degradation experiment. The culture was performed at a temperature of 30° C. for 72 h respectively. The removal effects on COD_{Mn}, TN, TP and NH₄⁺-N were determined. The removal rates were 89.8%, 86.5%, 90.5%, and 88.8% respectively.

### Example 3

4 parts of 200 mL sewage water sample was taken, and cadmium, copper, lead and chromium were respectively added in an amount of 0.04 mg to respectively obtain 4 samples, in which the metal ion concentration was 0.2 mg/kg;

The microbial agent in Example 1 was inoculated into the 4 samples in a dose of 0.3%, cultured at 30° C. in a dark shaker, and sampled on the second and third days, and the content of metal ions in the sample was determined by atomic absorption spectrophotometry, as shown in Table 2.

TABLE 2
Metal ion adsorption and removal effect of microbial agent

| Sampling | Cadmium | Copper | Lead | Chromium |
|---|---|---|---|---|
| Time | mg/kg | mg/kg | mg/kg | mg/kg |
| 0 | 0.2 | 0.2 | 0.2 | 0.2 |
| 48 h | 0.038 | 0.087 | 0.096 | 0.052 |
| 72 h | 0.021 | 0.075 | 0.087 | 0.033 |

It can be seen from Table 2 that the microbial agent of the present invention has good adsorption and removal effects on heavy metal ions such as cadmium, copper, lead and chromium, and the removal efficiencies on cadmium, copper, lead and chromium after 2 d respectively reach 81.0%, 56.5%, 52.0% and 74.0%, wherein the adsorption and removal effects on cadmium and chromium are the most obvious.

### Example 4

Preparation of microbial agent: P. aeruginosa CICC 10351, Pseudomonas stutzeri CICC 23621 and B. cereus CICC 21155 were respectively cultured in a nutrient broth agar medium to obtain P. aeruginosa CICC 10351 fermentation broth, P. stutzeri CICC 23621 fermentation broth and B. cereus CICC 21155 fermentation broth; Staphylococcus CICC 10311 was cultured in a wort agar medium to obtain Staphylococcus CICC 10311 fermentation broth; P. membranifaciens CICC 33242 was cultured in a wort agar medium to obtain P. membranifaciens CICC 33242 fermentation broth;

According to parts by weight, 10 parts of the P. aeruginosa CICC 10351 fermentation broth, 10 parts of the P. stutzeri CICC 23621 fermentation broth, 20 parts of the B. cereus CICC 21155 fermentation broth, 5 parts of the Staphylococcus CICC 10311 fermentation broth, and 5 parts of the P. membranifaciens CICC 33242 fermentation broth were mixed to obtain a composite microbial agent.

### Example 5

Preparation of microbial agent: P. aeruginosa CICC 10351, P. stutzeri CICC 23621, P. brenneri CICC 10271 and B. cereus CICC 21155 were respectively cultured in a nutrient broth agar medium to obtain P. aeruginosa CICC 10351 fermentation broth, P. stutzeri CICC 23621 fermentation broth, P. brenneri CICC 10271 fermentation broth and B. cereus CICC 21155 fermentation broth; Staphylococcus CICC 10311 was cultured in a wort agar medium to obtain Staphylococcus CICC 10311 fermentation broth; P. membranifaciens CICC 33242 was cultured in a wort agar medium to obtain P. membranifaciens CICC 33242 fermentation broth;

According to parts by weight, 10 parts of the P. aeruginosa CICC 10351 fermentation broth, 10 parts of the P. stutzeri CICC 23621 fermentation broth, 10 parts of P. brenneri CICC 10271 fermentation broth, 15 parts of the B. cereus CICC 21155 fermentation broth, 10 parts of the Staphylococcus CICC 10311 fermentation broth, and 10 parts of the P. membranifaciens CICC 33242 fermentation broth were mixed to obtain a composite microbial agent.

### Example 6

Preparation of microbial agent: P. stutzeri CICC 23621 and B. cereus CICC 21155 were respectively cultured in a nutrient broth agar medium to obtain P. aeruginosa CICC 10351 fermentation broth, P. stutzeri CICC 23621 fermentation broth and B. cereus CICC 21155 fermentation broth; Staphylococcus CICC 10311 was cultured in a wort agar medium to obtain Staphylococcus CICC 10311 fermentation broth; P. membranifaciens CICC 33242 was cultured in a wort agar medium to obtain P. membranifaciens CICC 33242 fermentation broth; Fusarium fujikuroi CICC 2489 was cultured in a potato agar medium to obtain F. fujikuroi CICC 2489 fermentation broth;

According to parts by weight, 25 parts of the P. stutzeri CICC 23621 fermentation broth, 30 parts of the B. cereus CICC 21155 fermentation broth, 5 parts of the Staphylococcus CICC 10311 fermentation broth, 5 parts of the P. membranifaciens CICC 33242 fermentation broth and 10 parts of F. fujikuroi CICC 2489 fermentation broth were mixed to obtain a composite microbial agent.

1000 mL of sewage water sample was taken, and 0.2% by mass of microbial agents obtained in Examples 4-6 were respectively added for water degradation experiments. The culture was performed at a temperature of 30° C. for 72 h respectively. The removal effects on COD_{Mn}, TN, TP and NH₄⁺-N were determined. The specific removal rate results are shown in Table 3.

TABLE 3
Removal effects of microbial agents obtained in Examples
4-6 on COD_{Mn}, TN, TP and NH₄⁺—N

| Microbial | COD_{Mn} | TN | TP | NH₄⁺—N |
|---|---|---|---|---|
| Agent | (mg/L) | (mg/L) | (mg/L) | (mg/L) |
| Example 4 | 9.16 | 6.08 | 0.55 | 5.94 |
| Example 5 | 8.95 | 5.41 | 0.53 | 5.50 |
| Example 6 | 7.46 | 5.12 | 0.48 | 4.29 |

Referring to the test method of Example 4, the heavy metal removal capacity of the composite microbial agents obtained in Examples 4-6 was respectively tested. The composite microbial agent was inoculated into the sample in a dose of 0.3%, cultured at 30° C. in a dark shaker, and sampled on the second day. The content of metal ions in the sample was determined by atomic absorption spectrophotometry. The results are shown in Table 4.

TABLE 4
Adsorption and removal effects of microbial
agents obtained in Examples 4-6 on metal ions

| Microbial | Cadmium | Copper | Lead | Chromium |
|---|---|---|---|---|
| Agent | mg/kg | mg/kg | mg/kg | mg/kg |
| Example 4 | 0.033 | 0.081 | 0.084 | 0.045 |
| Example 5 | 0.029 | 0.078 | 0.089 | 0.048 |
| Example 6 | 0.022 | 0.065 | 0.071 | 0.039 |

### Comparative Example

The formula of the microbial agent was replaced by the microbial agent 1, the microbial agent 2, the microbial agent 3, and the microbial agent 4, wherein the components of the microbial agents 1, 2, 3, and 4 are as follows:

Microbial agent 1: No Pseudomonas was added, and other conditions were kept unchanged with reference to the preparation method of the microbial agent in Example 1.

Microbial agent 2: P. pastoris was replaced with Saccharomyces cerevisiae, other conditions are kept unchanged with reference to the preparation method of the microbial agent in Example 1; (Saccharomyces cerevisiae ACCC21144, see document Dai Youzhi, Xu Caixia. Adsorption of Cr (VI) in Water by Saccharomyces cerevisiae [J]. Natural Science Journal of Xiangtan University, 2007, 29(3), 79-83.).

Microbial agent 3: No P. pastoris was added, and other conditions were kept unchanged with reference to the preparation method of the microbial agent in Example 1.

Microbial agent 4: No Staphylococcus was added, and other conditions were kept unchanged with reference to the preparation method of the microbial agent in Example 1.

Microbial agent 5: The parts by weight of the Staphylococcus in Example 1 were replaced with 2 parts, and other conditions were kept unchanged with reference to the preparation method of the microbial agent in Example 1.

Microbial agent 6: The parts by weight of the Staphylococcus in Example 1 were replaced with 25 parts, and other conditions were kept unchanged with reference to the preparation method of the microbial agent in Example 1.

The sewage treatment was carried out in accordance with the method of Example 1, and the test results of the treated sewage are as shown in Table 5.

TABLE 5
Index results of treated sewage (0.2% dose)

| Microbial | COD_{Mn} | TN | TP | NH₄⁺—N |
|---|---|---|---|---|
| Agent | (mg/L) | (mg/L) | (mg/L) | (mg/L) |
| 0 (not added) | 54.61 | 35.15 | 3.14 | 31.58 |
| Microbial | 38.35 | 28.79 | 2.75 | 28.91 |
| agent 1 | | | | |
| Microbial | 36.18 | 25.45 | 2.56 | 25.33 |
| agent 2 | | | | |
| Microbial | 42.12 | 30.30 | 2.33 | 24.85 |
| agent 3 | | | | |
| Microbial | 26.80 | 22.24 | 1.94 | 18.17 |
| agent 4 | | | | |
| Microbial | 20.21 | 17.46 | 2.03 | 15.94 |
| agent 5 | | | | |
| Microbial | 35.37 | 26.60 | 2.42 | 27.11 |
| agent 6 | | | | |

The heavy metal ions were treated in accordance with the method of Example 3, and the contents of the heavy metal ions after the treatment are as shown in Table 6.

| Microbial | Cadmium | Copper | Lead | Chromium |
|---|---|---|---|---|
| Agent | mg/kg | mg/kg | mg/kg | mg/kg |
| Microbial | 0.135 | 0.155 | 0.145 | 0.120 |
| agent 1 | | | | |
| Microbial | 0.128 | 0.146 | 0.148 | 0.153 |
| agent 2 | | | | |
| Microbial | 0.153 | 0.166 | 0.170 | 0.161 |
| agent 3 | | | | |
| Microbial | 0.165 | 0.184 | 0.187 | 0.152 |
| agent 4 | | | | |
| Microbial | 0.088 | 0.112 | 0.125 | 0.092 |
| agent 5 | | | | |
| Microbial | 0.146 | 0.150 | 0.161 | 0.045 |
| agent 6 | | | | |

Referring to Table 1 to Table 4, it can be seen that the interaction between the various strains in the microbial agent of the present invention exists, and the various strains can be well fermented and symbiotic. It can be seen from the microbial agent 1 that the decontamination performance of the system without Pseudomonas is significantly decreased, and the adsorption capacity is also not good. It can be seen from the microbial agent 2 that the S. cerevisiae has poor symbiotic effect with other strains in the microbial agent system of the present invention, and the corresponding decontamination effect and metal ion adsorption capacity are poor. In addition, Staphylococcus has a very important influence on the heavy metal ion adsorption performance of the microbial agent, and the microbial agent without Staphylococcus (microbial agent 4) has a certain nitrogen and phosphorus removal effect, but the metal ion adsorption performance is very poor. At the same time, according to the microbial agents 5 and 6, the added amount of the Staphylococcus has a great influence on the decontamination and metal ion removal effects, and too little or too much additive will obviously inhibit the effect of the composite microbial agent.

Although the present invention has been disclosed in the above preferred examples, the present invention is not limited thereto. Any modifications and variations can be made without departing from the spirit and scope of the present invention, and therefore, the scope of the present invention should be determined by the scope of the appended claims.

What is claimed is:

1. A heavy metal ion treatment method, wherein the method comprises adding the microbial agent to a sample to remove heavy metal ions in the sample, the microbial agent comprising the following components in parts by weight: 20-30 parts of Pseudomonas, 15-30 parts of Bacillus, 5-15 parts of Staphylococcus, and 5-15 parts of Pichia pastoris.

2. The method according to claim 1, wherein the Pseudomonas comprises one or more of Pseudomonas aeruginosa, Pseudomonas brenneri, Pseudomonas putida, and Pseudomonas stutzeri.

3. The method according to claim 1, wherein the Pichia pastoris is Pichia membranifaciens.

4. The method according to claim 1, the microbial agent comprising the following components in parts by weight: 25 parts of Pseudomonas, 20 parts of Bacillus, 15 parts of Staphylococcus and 10 parts of Pichia pastoris.

5. The method according to claim 2, the microbial agent comprising the following components in parts by weight: 25 parts of Pseudomonas, 20 parts of Bacillus, 15 parts of Staphylococcus and 10 parts of Pichia pastoris.

6. The method according to claim 3, the microbial agent comprising the following components in parts by weight: 25 parts of Pseudomonas, 20 parts of Bacillus, 15 parts of Staphylococcus and 10 parts of Pichia pastoris.

7. The method according to claim 1, the microbial agent comprising the following component in parts by weight: 5-20 parts of Fusarium.

8. The method according to claim 1, wherein the added amount of the microbial agent is not less than 0.2%.

9. The method according to claim 1, further comprises enriching the microbial agent onto a carrier, the carrier being a spongy cube carrier ACP or PM.

10. The method according to claim 9, wherein the content of the strain relative to the carrier is not less than 10 μg/g.

11. The method according to claim 10, wherein the content of the strain relative to the carrier is 50-150 μg/g.

12. A sewage treatment method, wherein the method comprises adding the microbial agent to the sewage to remove pollutants in the sewage, the microbial agent comprising the following components in parts by weight: 20-30 parts of Pseudomonas, 15-30 parts of Bacillus, 5-15 parts of Staphylococcus, and 5-15 parts of Pichia pastoris.
